(19) United States
(12) Patent Application Publication
(10) Pub. No.: US 2026/0237184 A1
(43) Pub. Date: Aug. 13, 2026

(54) SYSTEM AND METHOD FOR CLUSTERING LiDAR POINT CLOUD BY USING ARTIFICIAL INTELLIGENCE

(71) Applicants: HYUNDAI MOTOR COMPANY, Seoul (KR); Kia Corporation, Seoul (KR)

(72) Inventors: Nam Gyun KIM, Gyeonggido (KR); Jae In LEE, Gyeonggido (KR)

(21) Appl. No.: 19/415,520

(22) Filed: Dec. 10, 2025

(30) Foreign Application Priority Data
Feb. 13, 2025 (KR) 10-2025-0018732

(51) Int. Cl. G06V 10/762; G06V 10/26; G06V 10/30; G06V 10/764; G06V 10/77

(52) U.S. Cl. CPC G06V 10/7625; G06V 10/26; G06V 10/30; G06V 10/764; G06V 10/77

(57) ABSTRACT

A system and a method for clustering LiDAR point cloud data through artificial intelligence (AI) machine learning for autonomous driving. The system includes a processor executing class merging for a plurality of classes respectively corresponding to a plurality of objects and generating a seed point list composed of a plurality of seed points respectively corresponding to a plurality of seed classes, selecting a clustering scheme and generating a data structure for the selected clustering scheme, determining a clustering priority for the plurality of seed classes, and segmenting the LiDAR point cloud data, depending on the clustering priority, and applying the selected clustering scheme to the segmented LiDAR point clouds.

### CROSS-REFERENCE TO RELATED APPLICATION

Pursuant to 35 U.S.C. § 119(a), this application claims the benefit of an earlier filing date and right of priority to Korean Patent Application No. 10-2025-0018732, filed in the Korean Intellectual Property Office on February 13, 2025, the entire contents of which are incorporated herein by reference.

### TECHNICAL FIELD

The present disclosure relates to a system and a method for clustering a light detection and ranging (LiDAR) point cloud by using artificial intelligence (AI).

### BACKGROUND

Recently, with the development and commercialization of autonomous vehicle, there has been an increase in examples of using various sensors an artificial intelligence (AI) technology to support an autonomous driving function of the vehicle. For example, research on which object is present in front of a vehicle which is driving, on how far the distance between the object and the vehicle is, on which algorithm the vehicle should respond according to for each specific situation to ensure safety has continued.

Thus, a vehicle sensor technology has become more advanced. There is a trend towards loading high-performance sensors, such as light detection and ranging (LiDAR) for recognizing a surrounding environment using laser beams, radio detection and ranging (RADAR) using radio waves, an ultrasonic sensor, a fisheye camera capable of capturing a 360-degree image, a multifocal lens, and a global positioning system (GPS), into the vehicle.

It is possible to aggregate the measured results obtained from the plurality of sensors to implement a so-called super sensor vehicle. The concept of a super sensor in self-driving or autonomous driving refers to a technology for combining measured values of various sensors to more accurately recognize a surrounding environment, rather than relying on an individual sensor, for convenience or safety of vehicle driving. As information and communications technology (ICT) and cloud technology are added to this, a sensor necessary for autonomous driving and an AI algorithm associated with it are becoming more advanced than ever, for example, may remotely accumulate data in units of a fleet of vehicles, rather than targeting only one vehicle, and may train an AI server and a database to increase the reliability of determination of the vehicle sensor.

Particularly, a LiDAR sensor for recognizing an external environment thereamong emits laser and measures the laser reflected from a surrounding object in terms of a time taken for reflection and laser intensity, thus recognize various objects which are present on the road on which the vehicle is performing autonomous driving.

Object recognition using the LiDAR and the AI algorithm is not perfected. Although the sensing performance of the LiDAR becomes advanced and the AI technology is developed, object recognition for an external environment around the vehicle which is performing autonomous driving may be incorrect. This may be a potential threat to safety of the autonomous driving.

Thus, there is a need for a LiDAR data clustering technique capable of improving object recognition performance by using AI upon autonomous driving.

### SUMMARY

According to an aspect of the present disclosure, an artificial intelligence (AI)-based system for clustering LiDAR point cloud data may include a processor executing class merging for a plurality of classes respectively corresponding to a plurality of objects included in the LiDAR point cloud data and generating a seed point list composed of a plurality of seed points respectively corresponding to a plurality of seed classes obtained from the class merging, selecting a clustering scheme for the LiDAR point cloud and generating a data structure for the selected clustering scheme, determining a clustering priority for the plurality of seed classes, and segmenting the LiDAR point cloud data to which the data structure is applied, depending on the clustering priority, and applying the selected clustering scheme to the segmented LiDAR point clouds.

In the AI clustering system for the LiDAR point cloud according to another aspect of the present disclosure, the process may additionally execute calculating a representative feature point corresponding to each cluster generated according to the selected clustering scheme from points included in each cluster and adjusting a threshold for each of the representative feature points in units of each cluster to generate feature point information in units of a cluster in which noise is removed.

In the AI clustering system for the LiDAR point cloud according to another aspect of the present disclosure, the class merging may be performed in such a manner as to perform dimension reduction of the LiDAR point cloud and aggregate two or more classes into one seed class on the basis of a feature distance.

In the AI clustering system for the LiDAR point cloud according to another aspect of the present disclosure, the necessary data structure may include one of a data structure about a range view (RV) pixel map, a data structure about a bird’s eye view (BEV) pixel map, a data structure about a BEV voxel map, or a density-based spatial clustering of applications with noise (DBSCAN)-based tree data structure.

In the AI clustering system for the LiDAR point cloud according to another aspect of the present disclosure, the clustering priority may be determined based on an average value of prediction scores for the plurality of seed points.

In the AI clustering system for the LiDAR point cloud according to another aspect of the present disclosure, a predetermined seed class order may be determined as the clustering priority, when the average value of the prediction scores does not meet a certain threshold range.

In the AI clustering system for the LiDAR point cloud according to another aspect of the present disclosure, the threshold range may be differently set for each seed class.

In the AI clustering system for the LiDAR point cloud according to another aspect of the present disclosure, an object recognition result for the LiDAR point cloud may be corrected by the seed class, when applying the selected clustering scheme.

In the AI clustering system for the LiDAR point cloud according to another aspect of the present disclosure, the representative feature point corresponding to each cluster may include one of a number of points in the cluster, a size of the cluster, density of the cluster, an eigen-value, a Z minimum value or a Z maximum value, or means intensity.

In the AI clustering system for the LiDAR point cloud according to another aspect of the present disclosure, the processor may additionally execute redefining a class assigned for each object recognized after the noise is removed in the result to which the selected clustering scheme is applied as a final class for the LiDAR point cloud.

Meanwhile, another aspect of the present disclosure relates to an AI clustering method for a LiDAR point cloud. The method for clustering a LiDAR point cloud point may include executing class merging for a plurality of classes respectively corresponding to a plurality of objects included in the LiDAR point cloud and generating a seed point list composed of a plurality of seed points respectively corresponding to a plurality of seed classes obtained from the class merging, selecting a clustering scheme for the LiDAR point cloud and generating a data structure for the selected clustering scheme, determining a clustering priority for the plurality of seed classes, and segmenting the LiDAR point cloud to which the data structure is applied, depending on the clustering priority, and applying the selected clustering scheme to the segmented LiDAR point clouds.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example of the overall system for controlling a vehicle to automatically recognize an object and perform autonomous driving according to an implementation of the present disclosure;

FIG. 2 is a flowchart illustrating an example of an AI clustering algorithm for a LiDAR point cloud according to an implementation of the present disclosure;

FIG. 3 is a drawing for describing an example of a process of aggregating and generating a seed class based on a feature distance analysis for a plurality of classes according to an implementation of the present disclosure;

FIG. 4 is a drawing for describing an example of a process of generating a seed class list composed of a plurality of seed points corresponding to each newly defined seed class according to an implementation of the present disclosure;

FIG. 5 is a drawing for describing an example of a process of performing noise processing on a cluster-by-cluster basis to generate cluster unit information according to an implementation of the present disclosure;

FIG. 6 is a drawing illustrating an example of an experimental result of applying an AI clustering algorithm for a LiDAR point cloud to correct misrecognition for an object according to an implementation of the present disclosure; and

FIG. 7 is a block diagram illustrating an example of a computing system for autonomous vehicle control and object recognition calculation according to an implementation of the present disclosure.

### DETAILED DESCRIPTION

The present disclosure relates to a system and a method for clustering a light detection and ranging (LiDAR) point cloud by using artificial intelligence (AI). In some implementations, a point cloud clustering related system and method utilize a seed class to facilitate improved class classification.

Implementations of the present disclosure can provide a technology for improving cluster performance by point clustering, which may improve instantiation performance of a LiDAR-based object.

Particularly, implementations of the present disclosure can merge a plurality of classes predefined for object recognition to compress the classes as a seed class and may generate points constituting each seed class object as seed classes, respectively.

In some implementations of the present disclosure, the seed class is not a final class (as criteria for clustering) but instead the seed class is utilized in searching for an improved clustering class. Thus, it is possible to perform accurate AI object recognition upon classification according to a final class, even for an object in which misclassification occurs on the basis of the predefined class.

For example, implementations of the present disclosure can derive a clustering scheme that is robust to various noise which interfere with AI object recognition based on point-based class information which is the segmentation result, thus improving object recognition performance. In some scenarios, implementations of the present disclosure can merge classes with a similar feature with each other to partially correct an inaccurate classification result of a segmentation process.

Particularly, in scenarios where clustering in LiDAR object recognition involves initially instantiating a point, it is possible to perform adaptive P-box calculation and object contour recognition in units of a newly defined class. These operations can be performed, for example, in a shape analysis step after class classification is applied.

In addition, those skilled in the air may understand various effects other than the effects described above from the present disclosure, via the detailed description of the present disclosure and the accompanying drawings.

Hereinafter, some implementations of the present disclosure will be described in detail with reference to the exemplary drawings. In adding the reference numerals to the components of each drawing, it should be noted that the identical component is designated by the identical numerals even when they are displayed on other drawings. Further, in describing the implementation of the present disclosure, a detailed description of well-known features or functions will be ruled out in order not to unnecessarily obscure the gist of the present disclosure.

In describing components of exemplary implementations of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

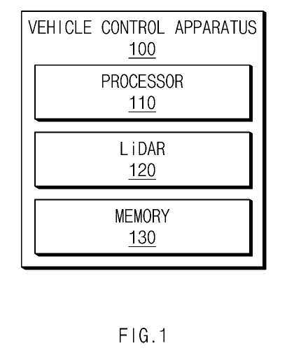

FIG. 1 is a block diagram illustrating an example of the overall system for controlling a vehicle to automatically recognize an object and perform autonomous driving according to an implementation of the present disclosure.

Referring to FIG. 1, a vehicle control apparatus 100 according to an implementation of the present disclosure may be implemented inside or outside a vehicle, and some of the components included in the vehicle control apparatus 100 may be implemented inside or outside the vehicle. In some implementations, the vehicle control apparatus 100 may be integrally configured with control units in the vehicle or may be implemented as a separate device to be connected with the control units of the vehicle by a separate connection technique. For example, the vehicle control apparatus 100 may further include components which are not shown in FIG. 1.

The vehicle control apparatus 100 according to an implementation may include a processor 110, a sensor 120, such as a light detection and ranging (LiDAR), and a memory 130. The processor 110, the sensor 120, and the memory 130 may be electronically or operably coupled with each other by an electronical component including a communication bus.

Hereinafter, that pieces of hardware are operably coupled with each other may include that a direct connection or an indirect connection between the pieces of hardware is established wired and/or wirelessly, such that second hardware is controlled by first hardware among the pieces of hardware.

Although different blocks are illustrated in FIG. 1, implementations are not limited thereto. For example, some of the pieces of hardware of FIG. 1 may be included in a single integrated circuit including a system on a chip (SoC). Types of the pieces of hardware included in the vehicle control apparatus 100 and/or the number of the pieces of hardware are/is not limited to those shown in FIG. 1. For example, the vehicle control apparatus 100 may include only some of the pieces of hardware shown in FIG. 1.

The vehicle control apparatus 100 according to an implementation may include hardware for processing data based on one or more instructions. For example, the hardware for processing the data may include the processor 110. For example, the hardware for processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad core, a hexa-core, or an octa core.

According to an implementation, the processor 110 may include at least one of a graphic processing unit (GPU) or a neural processing unit (NPU), or any combination thereof. For example, the GPU may be referred to as a visual processing unit (VPU). For example, the NPU may be referred to as a neural network processing unit.

The vehicle control apparatus 100 according to an implementation may include a sensor 120, such as a depth sensor for detecting an external object. For example, the sensor 120 for detecting the external object may include at least one of a time of flight (ToF) sensor, a LiDAR, a structured light sensor, an ultrasonic sensor, an infrared sensor, radio detection and ranging (RADAR), or an optical distance sensor, or any combination thereof. Hereinafter, a description will be given of the sensor 120 implemented as LiDAR for convenience of description, but implementations are not limited thereto, and in general the sensor 120 can be implemented as other types of sensors.

The vehicle control apparatus 100 according to an implementation may include the LiDAR sensor 120 (or simply referred to as LiDAR 120) for obtaining a plurality of points based on a pulse laser signal. For example, the LiDAR 120 may obtain datasets for identifying an object around the vehicle control apparatus 100 (or the vehicle including the vehicle control apparatus 100). For example, the LiDAR 120 may identify at least one of a position of the object, a motion direction of the object, or a speed of the object, or any combination thereof, based on that a pulse laser signal radiated from the LiDAR 120 is reflected from the object to return.

For example, the LiDAR 120 may obtain datasets representing the external object on a space formed by an x-axis, a y-axis, and a z-axis, based on the pulse laser signal reflected from the object. For example, the LiDAR 120 may obtain datasets including a plurality of points in the space formed by the x-axis, the y-axis, and the z-axis, based on receiving the pulse laser signal at a specified period. For example, the plurality of points may include points representing the external object in a three-dimensional (3D) virtual coordinate system. The 3D virtual coordinate system may include at least one of a virtual coordinate system or a LiDAR coordinate system, or any combination thereof. However, the example of the 3D virtual coordinate system is not limited to those described above.

The memory 130 of the vehicle control apparatus 100 according to an implementation may include a hardware component for storing data and/or an instruction input and/or output from the processor 110 of the vehicle control apparatus 100. For example, the memory 130 may include a volatile memory including a random-access memory (RAM) and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

One or more instructions indicating calculation and/or an operation to be performed using data by the processor 110 of the vehicle control apparatus 100 may be stored in the memory 130 of the vehicle control apparatus 100. A set of the one or more instructions may be referred to as a program, firmware, an operating system, a process, a routine, a sub-routine, and/or an application.

Hereinafter, that the application is installed in the vehicle control apparatus 100 may mean that one or more instructions provided in the form of the application are stored in the memory 130, which may mean that the one or more instructions are stored in a format executable by the processor 110 of the vehicle control apparatus 100 (e.g., as a file with an extension specified by the operating system of the vehicle control apparatus 100).

For example, the memory 130 may include a first neural network model for detecting an object. For example, the memory 130 may include a second neural network model for outputting a type of the plurality of points obtained by the LiDAR 120 and/or a score of the plurality of points.

In an implementation, the processor 110 may obtain at least one of a first virtual box for representing a target object or a first class indicating a type of the target object, or any combination thereof, based on the plurality of points obtained via the LiDAR 120 and the first neural network model stored in the memory 130.

In an implementation, the processor 110 may obtain at least one of the first virtual box for representing the target object or the first class indicating the type of the target object, or any combination thereof, based on inputting the plurality of points to the first neural network model. For example, the first neural network model may include an object detection model. For example, the target object may include an external object located within a specified distance from the vehicle control apparatus 100 (or a host vehicle including the vehicle control apparatus 100). For example, the target object may include an object which identified by the vehicle control apparatus 100 and is tracked, e.g., continuously tracked. For example, the type of the target object may include one or more of a plurality of types for classifying the target object. For example, the type of the target object may include at least one of a first type indicating the ground or a second type indicating a type different from the ground, or any combination thereof. However, the type of the target object is not limited to those described above. For example, the type of the target object may include, but is not limited to, at least one of a third type indicating a person or a fourth type indicating a vehicle, or any combination thereof.

In an implementation, the processor 110 may obtain at least one of first partial points corresponding to at least a portion of the target object among the plurality of points, based on the plurality of points and the second neural network model or a second class identified via the first partial points and indicating the type of the target object, or any combination thereof, based on the plurality of points and the second neural network model. For example, the second neural network model may include a segmentation model.

For example, the second neural network model may include a neural network model for obtaining the type of the plurality of points and the score of the plurality of points.

For example, the processor 110 may obtain the first partial points corresponding to the at least a portion of the target object among the plurality of points, based on inputting the plurality of points to the second neural network model. For example, the processor 110 may identify the type of the plurality of points, based on inputting the plurality of points to the second neural network model. For example, the processor 110 may obtain the first partial points corresponding to the at least a portion of the target object among the plurality of points, based on the type of each of the plurality of points.

According to an implementation, the processor 110 may perform a first specified algorithm for the plurality of points. For example, the processor 110 may perform the first specified algorithm for classifying the type of each of the plurality of points, for the plurality of points. For example, the processor 110 may classify second partial points corresponding to a specified type among the plurality of points. For example, the specified type may include a type representing the ground.

For example, the processor 110 may classify the second partial points corresponding to the specified type, based on performing the first specified algorithm for the plurality of points, and may exclude the second partial points from the plurality of points to obtain (or identify) the first partial points.

In an implementation, the processor 110 may obtain at least one of a partial class for obtaining the second class, or the score of each of the plurality of points, or any combination thereof, based on inputting the plurality of points to the second neural network model. For example, the processor 110 may obtain the partial class and the score of each of the plurality of points, based on inputting the plurality of points to the second neural network model. For example, the partial class may include classifying each of the plurality of points as any type.

For example, the processor 110 may fuse the partial class, the score of each of the plurality of points, and the second partial points. For example, the processor 110 may perform clustering, based on fusing the partial class, the score of each of the plurality of points, and the second partial points. For example, the clustering may include grouping the first partial points corresponding to the at least a portion of the target object.

For example, the processor 110 may obtain a point cloud for generating a second virtual box, based on the first partial points. For example, the processor 110 may obtain the point cloud, based on grouping the first partial points.

For example, the processor 110 may generate the second virtual box which is different from the first virtual box and is for representing the target object, based on the point cloud. For example, the second virtual box may include a box including at least some of the first partial points.

For example, the processor 110 may identify a heading direction indicating a progress direction of the target object, based on at least one of the first partial points or the point cloud, or any combination thereof.

For example, the processor 110 may identify a position of the second virtual box on the virtual coordinate system, based on the at least one of the first partial points or the point cloud, or the any combination thereof. For example, the processor 110 may identify a size of the second virtual box, based on the at least one of the first partial points or the point cloud, or the any combination thereof. For example, the processor 110 may identify a second class, based on the at least one of the first partial points or the point cloud, or the any combination thereof. For example, the processor 110 may identify at least one of the heading direction of the progress direction of the target object, the position of the second virtual box on the virtual coordinate system, the size of the second virtual box, or the second class, or any combination thereof, based on the at least one of the first partial points or the point cloud, or the any combination thereof. For example, the processor 110 may identify a heading direction of a bounding box, based on at least one of the first virtual box, the first class, the heading direction of the second virtual box, the position of the second virtual box, the size of the second virtual box, or the second class, or any combination thereof. For example, the processor 110 may identify a position of the bounding box on the virtual coordinate system, based on at least one of the first virtual box, the first class, the heading direction of the second virtual box, the position of the second virtual box, the size of the second virtual box, or the second class, or any combination thereof. For example, the processor 110 may obtain a third class indicating the type of the target object corresponding to the bounding box, based on at least one of the first virtual box, the first class, the heading direction of the second virtual box, the position of the second virtual box, the size of the second virtual box, or the second class, or any combination thereof. For example, the processor 110 may obtain at least one of the heading direction of the bounding box, the position of the bounding box on the virtual coordinate system, or the third class indicating the type of the target object corresponding to the bounding box, based on the at least one of the first virtual box, the first class, the heading direction of the second virtual box, the position of the second virtual box, the size of the second virtual box, or the second class, or the any combination thereof.

For example, the processor 110 may assign, to the second virtual box, a first identifier for tracking the second virtual box. For example, the processor 110 may assign, to the bounding box, a second identifier corresponding to the first identifier.

For example, the processor 110 may track the bounding box using the second identifier. For example, the processor 110 may track the target object, based on identifying a plurality of bounding boxes including the bounding box to which the second identifier is assigned, at a plurality of frames. For example, in scenarios where the second identifier is an identifier assigned to the bounding box corresponding to the target object, the processor 110 may identify the plurality of bounding boxes to which the second identifier is assigned, at the plurality of frames, to track the target object.

In an implementation, the processor 110 may output the bounding box corresponding to the target object, based on at least one of the first virtual box, the first class, the first partial points, or the second class, or any combination thereof. For example, the bounding box may include an example of representing the target object on the virtual coordinate system in the form of a hexahedron.

Hereinafter, a description will be given of operations performed by the CPU, the GPU, and/or the NPU included in the processor 110.

According to an implementation, the processor 110 may include at least one of the CPU, the GPU, or the NPU, or any combination thereof. For example, at least one of the GPU or the NPU, or any combination thereof may obtain the first virtual box and the first class, based on the first neural network model. For example, at least one of the GPU or the NPU may obtain the first virtual box and the first class. For example, the at least one of the GPU or the NPU, or the any combination thereof may obtain the partial class for obtaining the second class and the score of each of the plurality of points, based on the second neural network model. For example, the at least one of the GPU or the NPU may obtain the partial class for obtaining the second class and the score of each of the plurality of points, based on the second neural network model. For example, the CPU may classify the second partial points corresponding to the specified type among the plurality of points, based on the first specified algorithm for classifying the type of each of the plurality of points from the plurality of points.

As described above, the vehicle control apparatus 100 according to an implementation may include the at least one processor 110. The vehicle control apparatus 100 may detect the target object using the at least one processor 110 to accurately detect the target object. Furthermore, by performing a parallel process, the vehicle control apparatus 100 may reduce a load for each processor.

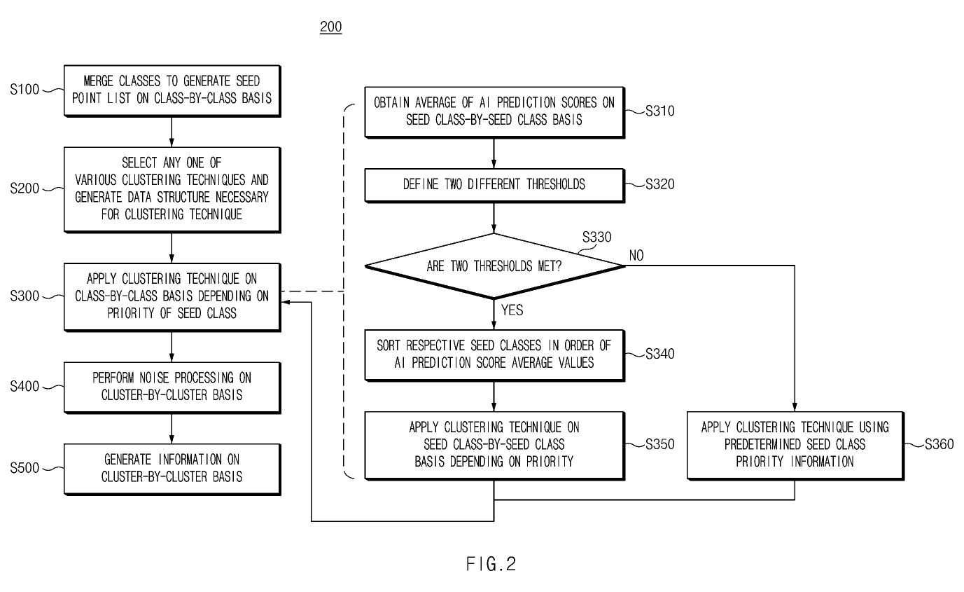

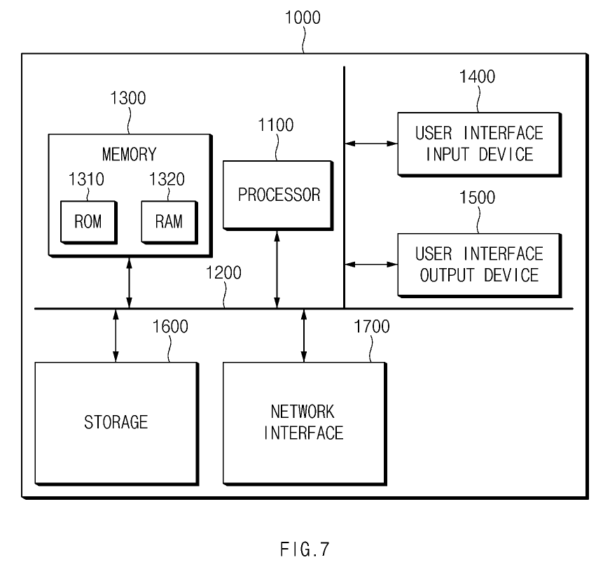

FIG. 2 is a flowchart illustrating an example of an AI clustering algorithm 200 for a LiDAR point cloud according to an implementation of the present disclosure. The AI-based object recognition algorithm 200 may operate as a software module by means of a processor 110 of FIG. 1. The processor 110 may execute the algorithm 200 with reference to point cloud sensing information from LiDAR 120 and various pieces of data stored in a memory 130. Furthermore, the processor 110 may be a part of a computing system 1000 shown in FIG. 7. Thus, the object recognition system 1000 according to the present disclosure may be substantially the same as the computing system 1000 shown in FIG. 7, which will be described below.

In some implementations, an object recognition process passes through three steps, such as pre-processing, segmentation, and tracking, by means of the LiDAR 120 and an AI module. FIG. 2 synthetically illustrates an example of segmentation and clustering steps to which implementations of the present disclosure is applied thereamong.

Object recognition is described next, including examples based on specific scenarios of a LiDAR object recognition process to understand the algorithm 200 according to the present disclosure, which is shown in FIG. 2. Hereinafter, a description will be given of an example of the overall recognition process.

Pre-processing can be performed by the object recognition system 1000 (e.g., refer to FIG. 7) , for example before executing an object recognition function. The pre-processing may include, for example, an operation of removing points forming the ground, based on laser sensing data (i.e., raw data) input from the LiDAR 120. Because a laser beam reflected from the ground could be mistakenly recognized as an object on the ground, the process of distinguishing between the ground and non-ground objects is performed in a preprocessing operation, and in some scenarios, can also be performed in a segmentation operation.

For example, the pre-processing in AI object recognition can implement a process in which an image processing tool of the AI module in the processor 110 can, for example, remove noise of a LiDAR point cloud image and reduce the total number of points which are present in the LiDAR point cloud image via a voxel downsampling technique or the like to promote computational efficiency.

For reference, the LiDAR point cloud image may be displayed in a bird’s eye view (BEV) scheme. When a LiDAR map is generated as if it were a bird's eye view of the city while the bird flies in the sky, this is referred to as a BEV image.

For example, as described above, the LiDAR 120 transmits a laser beam to a surrounding environment and records a round-trip time during which the laser beam is reflected from an object which is present in the outside and detected by the LiDAR 120, thus generating a point for each of many laser signals, based on which a distance to the point can be calculated. By repeatedly transmitting many laser beams, the processor 110 may generate a real-time LiDAR map for the surrounding environment as a BEV type of 3D map and may generate the real-time LiDAR map as a two-dimensional (2D) map in some scenarios.

The line or surface shown in black on the LiDAR point cloud map can be composed of a large number of points (e.g., each of which is generated based on the laser beam of the LiDAR 120). Due to this, a LiDAR sensing image is called a LIDAR point cloud image. In some implementations, when combining a red, green, blue - depth (RGB-D) sensor and a LiDAR sensor, the LiDAR point cloud image can be reconstructed in color.

Although it can be difficult for humans to recognize an object using only one of many points in the LiDAR point cloud image, a comprehensive view of the point cloud from the BEV’s point of view or in the same way as a 2D floor plan can enable a human viewer to obtain a better understanding of the surrounding environment around the vehicle which is currently performing autonomous driving. In addition, for example, it is possible to recognize a vehicle, a bus, a pedestrian, a street tree, a traffic sign, or other objects which are present in the LiDAR point cloud image. It is possible to classify the object as a class which belongs to a group of the specific nature, such as a vehicle class or a bus class or the like.

In some implementations, machine-learning networks such as a deep AI neural network can be used to classify whether any object in the LiDAR point cloud image is the vehicle class or the bus class or the like. In some cases, AI training can be implemented as a precedent step performed before deploying the machine-learning network to find objects in the LiDAR point cloud image and identify a class of the object.

The AI training can be performed utilizing datasets. For example, a dataset (source: https://pandaset.org/#data-collection) called PANDASET^{TM} includes more than 48,000 camera images (images captured primarily in the Silicon Valley region of the United States) and includes more than 16,000 LiDAR scan images. A total of 28 classes, such as pedestrians, cars, bicycles, construction site signs, and traffic signs, are arranged in the form of an annotation in these images.

Furthermore, the LiDAR point cloud image 210 can be visualized to suit an option desired by a user using a cloud work tool, such as Open3D^{TM} (source: https://www.open3d.org/). Because the LiDAR 120 is able to detect a distance, it may more realistically reproduce a 3D LiDAR image in such a manner as to display an object in a long distance in, for example, a deep blue and display an object in a short distance in a light blue, when the LiDAR point cloud image is visually processed using, for example, Open3D^{TM}.

In addition, as described above, in some implementations, technology such as voxel (3D pixel) downsampling, can be applied to the LiDAR point cloud image to pre-process an original LiDAR image (i.e., raw data). Herein, the voxel refers to a 3D pixel in the shape of a regular hexahedron and the voxel downsampling is a technology for reducing the number of points not to require excessive AI calculation, even while maintaining a structure of various objects included in the LiDAR point cloud.

In some implementations, the LiDAR 120 radiates, for example, m laser beams n times during one scan cycle. In this case, the scan values of the various laser beams that reflect off an external object can be collectively represented as an (m x n) matrix. This (m x n) matrix data is called a range image. Each point constituting the LiDAR point cloud image can include, for example, depth (i.e., range) information and may further include intensity, an azimuth, an inclination, or the other additional information of the reflected laser pulse. In some scenarios, the range image includes a large amount of datasets, for example, Waymo^{TM} open dataset (WOD). As such, it is possible to perform AI learning of the range image.

A range view (RV) refers to a technique for converting a 3D point cloud into a 2D scene, for example, 2.5D scene to represent the 3D point cloud as a 3D LiDAR map that humans are able to intuitively understand, like an analog picture. The 3D LiDAR point cloud image has 2D coordinates in the range view image, but the 3D laser related information (e.g., the angle, the inclination, the intensity, and the like) which is recorded when previously obtaining the range image is not discarded. When a variable called a width is applied to (x, y) coordinates among (x, y, z) coordinate values of the 3D LiDAR image to obtain a coordinate on one axis in two dimensions and range image information indicating a range (depth) and a variable called a height are applied to the (z) coordinate to obtain a coordinate of the other axis in two dimensions, this is generated as a 2D range view image.

In addition, the AI algorithm 200 according to implementations of the present disclosure can include a convolutional neural network (CNN). The CNN can be utilized for AI training to extract a feature (or a feature point) from image data. For example, the AI training can utilize a dataset composed of tens of thousands of commercially available images. The CNN can perform processing of each of one-dimensional to three-dimensional images. As such, the result of a range view image processing tool can be learned by the CNN to perform a function of helping AI to accurately recognize an object in an image.

In scenarios where objects around an autonomous vehicle are recognized through machine-learning, the operation of generating a ground truth (GT) bounding box on the above-mentioned LiDAR map is an important process in object recognition. Ground truth (GT) in machine learning is a term used when indicating an original value and a real value of data that the AI machine-learning network is utilized to learn. It may be usually viewed as a kind of image annotation overlaid on the LiDAR point cloud image as a bounding box with a box-shaped boundary.

For example, in performing object recognition, the AI module can determine a label to performing grouping of various objects. In some scenarios, an interval or spacing of 3D data points that are used to output a GT bounding box may be set, so that, for example, approximately 50 to 1000 LiDAR point cloud points are included in one GT bounding box.

In some implementations, there is no GT annotation present in original data (or raw data) captured by the sensor, such as the LiDAR 120, while the vehicle is driving. In such scenarios, the processor 110 can perform recognition of a target which belongs to various classes, such as a road sign, a crosswalk, a pedestrian, another vehicle, and a center line, as an object. The GT annotation can involve comparing the result of determining the object recognized by the AI algorithm 200 of the processor 110 with reality to measure an error in object recognition and evaluate AI performance. A GT bounding box overlaid on the original image in the form of an annotation can be set manually by the user, or can be set through a GT calculation tool, such as grid-striding.

AI object recognition can also utilize predicted bounding boxes. A predicted bounding box can represent a result of recognizing an object of a specific class by the processor 110 from the original image data obtained from sensors such as the LiDAR sensor 120. The predicted bounding boxes are the result of being calculated by autonomous driving AI. The predicted bounding box may be identical to the GT bounding box, or may partially overlap the GT bounding box or may not overlap at all with the GT bounding box.

In general, it can be difficult to definitively conclude that an object of a specific class is actually present at a specific position using only predicted bounding boxes. As such, the predicted bounding boxes are also referred to as probability boxes (P-boxes).

Segmentation processing can be performed after the pre-processing. Segmentation process can result in, for example, displaying a specific portion of an environment (e.g., traffic lights) with a particular annotation (e.g., in color red) and displaying other portions of the environment (e.g., bituminous road) using other annotations (e.g., in color blue). Segmentation can also involve clustering the point cloud into one or more groups to generating P-boxes.

In some implementations, clustering based on the point cloud and P-box generation can be performed during the segmentation processing. For example, an AI network which performs segmentation can be used to obtain a point label from data collected by sensors, such as the LiDAR sensor 120.

Implementations of the present disclosure can utilize a “rule-based” road surface recognition and label fusion technique, which can help mitigate problems of ground surface recognition error which can occur upon segmentation. Road surface recognition algorithms can apply any of various techniques, such as road surface recognition based on a slope, a grid-based road surface recognition, and the other non-planar based road surface recognition.

As described above, an error in road surface recognition may occur. For example, a frequent error classification phenomenon of a segmentation AI network may occur in a very short range. Although any of the slope-based technique, the grid-based technique, and the non-planar based technique can be applied in most environments due to high LiDAR point density in the very short range, a qualitative or quantitative result difference is not large.

Thus, implementations of the present disclosure can apply the “rule-based” road surface recognition and label fusion technique in the segmentation step, other than the clustering algorithm 200 which will be described below.

For reference, semantic segmentation can involve attaching a unique class label to respective points in the point cloud generated by the LiDAR 120. The semantic segmentation can find and use meaningful information from LiDAR data for object recognition or scene representation to implement autonomous driving. Various semantic segmentation AI modes can be used, such as a projection-based method, a point-based method, and a sparse convolution-based method. For example, the semantic segmentation result can be the AI calculation result performed together with the NVIDIA DRIVE™ AGX system by the processor 110. Using such a configuration, various annotations such as colors may be added to, for example, the LiDAR point cloud image.

According to some implementations, the image input upon object recognition processing may be the RV image described above. The image can be a 2D BEV image or a 2.5D BEV image, for example. Furthermore, the frame of the LiDAR image can be a single frame or a multi-frame. An instantiation technique is able to apply the above-described semantic segmentation and a panoptic segmentation technique. An encoder is able to apply a convolutional encoder and a CNN transformer encoder.

After performing the segmentation process described above, in some implementations the LiDAR image can undergo post-processing. Post-processing can involve converting point cloud data into a 3D map or modeling, which can be information meaningful for autonomous driving. Post-processing can also involve, in some scenarios, removing noise of the LiDAR point cloud image or an error in the LiDAR point cloud image, recognizing an object, such as a vehicle or a pedestrian, from the point cloud, and attaching and registering a unique identifier to the point cloud information.

In some implementations, cluster expansion can also be utilized. In such scenarios, an expansion target may include a cluster that is expanded to include all points within a given distance from the seed point plus an additional incremental distance epsilon (where the given distance constitutes the unexpanded cluster).

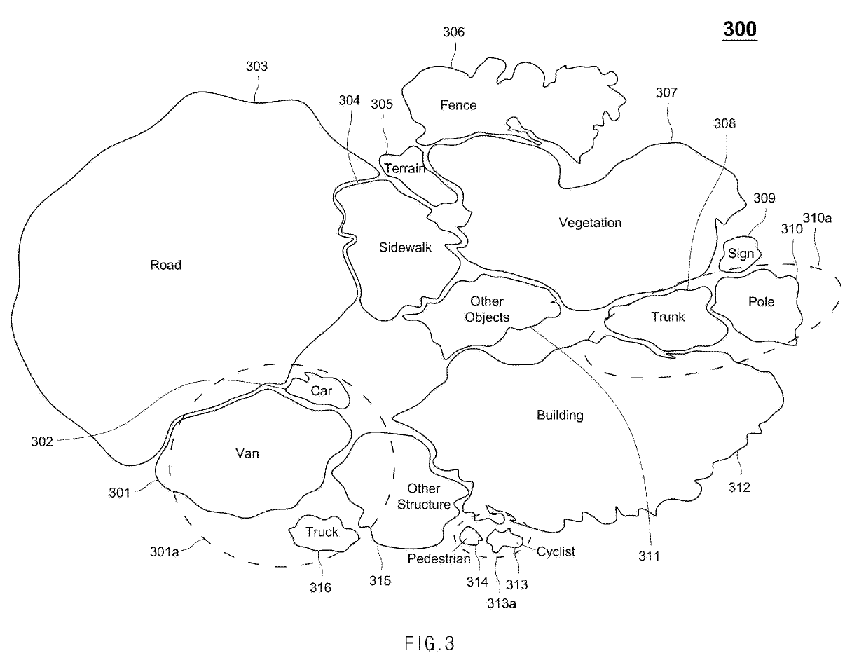

Hereinafter, referring again to FIG. 2, a description will be given in detail of an example of the AI clustering algorithm 200 according to the present disclosure. The AI clustering algorithm 200 according to the present disclosure can implement a flexible clustering technique for each class. A description will be given in detail below. For ease of description and comprehensive explanation, the descriptions of the various steps of FIG. 2 will be provided in conjunction with occasional references to FIGS. 3 to 6.

First of all, in S100, classes may be merged to generate a seed point list on a class-by-class basis. In some implementations, the process of categorizing classes can involve a heuristic technique for performing dimension reduction to analyze a class feature distance, performing a relative confusion matrix analysis (e.g., performing class merging and proceeding with the class merging based on the confusion matrix calculation result evaluated as having the best AI performance), or taking into account trial and error.

As an example, FIG. 3 is a drawing for describing an example of a process of aggregating and generating a seed class based on a feature distance analysis for a plurality of classes according to an implementation of the present disclosure.

In FIG. 3, the LiDAR 120 and AI module may detect objects which belong to various classes, for example, a van 301, a car 302, a road 303, a sidewalk 304, a terrain 305, a fence 306, vegetation 307, a trunk 308, a traffic sign 309, a pole 310, the other objects 311, a building 312, a cyclist 313, a pedestrian 314, the other structures 315, and a truck 316.

FIG. 3 illustrates an example of dimension reduction data 300 of LiDAR point cloud data actually composed of many points.

Implementations of the present disclosure can perform merging of classes based on feature distance analysis. For example, in FIG. 3, three classes can be merged, such as the van 301, the car 302, and the truck 316, to execute class merging as a merged class. This merging can be based on feature distances of the van 301, the car 302, and the truck 316 being very close to each other, for example, when applying dimension reduction modeling as shown in FIG. 3 The merged class can be referred to as a vehicle 301a.

Similarly, for example, the trunk 308 and the pole 310 can be merged into a merged class, such as a long object 310a. Furthermore, in this example, the pedestrian 314 and the cyclist 313 can be merged into one to generate a merged class, such as a person 313a.

In some implementations, a confusion matrix can be utilized as described above. The confusion matrix can be used for dividing and calculating an AI calculation result into the number of four cases, such as true positive (TP), false positive (FP), true negative (TN), and false negative (FN), depending on whether the result predicted by AI is identical to the real result to evaluate AI performance and performing parameter calculation for executing AI performance evaluation, such as F1 score. For example, according to implementations of the present disclosure, S100 may be executed by a process of observing whether the F1 score is improved to find a merged class with the best improvement degree of AI performance, when newly defining the trunk 308 and the pole 310 as the merged class, such as the long object 310a.

In implementations of the present disclosure, regardless of the specific scheme utilized, as described above, S100 is executed to define the merged classes (e.g., 301a, 310a, 313a, or the like) as “seed classes”. Thus, in scenarios where a plurality of original classes are defined, the merging process can generate N seed classes which is less than the number of original classes.

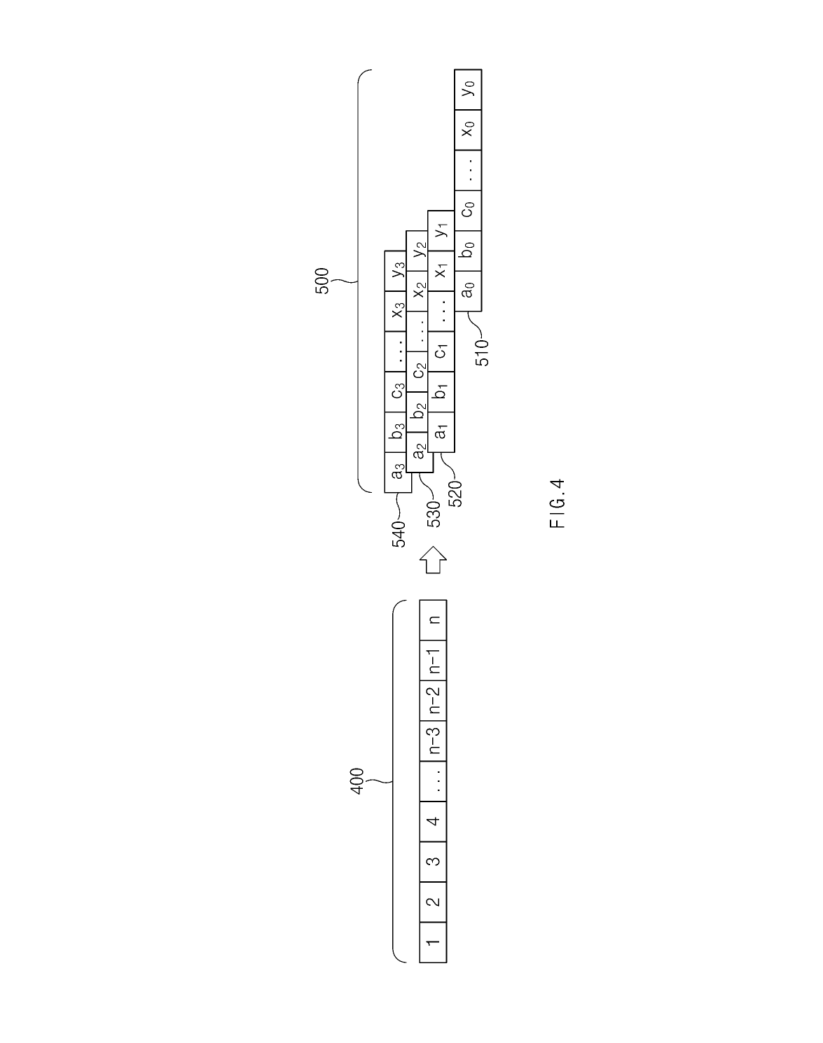

FIG. 4 is a drawing for describing an example of a process of generating a seed class list composed of a plurality of seed points corresponding to each newly defined seed class according to an implementation of the present disclosure.

For example, the entire seed point list 400 for each class merged in FIG. 4 is a set of many individual points, such as points 1, 2, 3, …, and n. According to implementations of the present disclosure, a plurality of seed points can be extracted, constituting each of seed classes, such as a vehicle 301, a long object 310a, and a person 313a. For example, in FIG. 4, reference numeral 510 arranges only points corresponding to a seed class, such as the vehicle 301a, reference numeral 520 arranges only points corresponding to another seed class, such as the long object 310a, and reference numeral 530 indicates points for another seed class, such as the person 313a. Points for the other objects are classified into, for example, reference numeral 540.

A dataset composed of reference numerals 510, 520, 530, 540, … in the present disclosure is referred to as a “seed point list 500”.

Referring back again to FIG. 2, in S200, any one of various clustering techniques can be selected and a data structure for the clustering technique can be generated. Clustering techniques can be composed of three steps of generating a data structure suitable for each technique, performing a search process and identification (ID) labeling, and performing the above-described post-processing process.

In some implementations, a class is determined by class classification passing through correction or the like in the process of applying the clustering technique in S200. This class is different from class information that is assigned in the seed list. Thus, due to flexibility and adaptivity in selecting a clustering technique, S200 can be performed, e.g., in real time, during object recognition. Thus, in scenarios where a clustering technique to be used is not yet determined, a data structure for each clustering technique candidate can be first generated based on candidates of the clustering technique expected to be selected.

For example, to apply an RV-based region growing technique, a range view (RV) pixel map data structure (e.g., a depth-view) can be generated. As another example, to apply the BEV-based 2D region growing technique, a BEV pixel map data structure can be generated in advance in S200. As yet another example, to apply a BEV-based 2.5D region growing technique, a data structure (e.g., Cylindrical-View) about a BEV voxel map can be generated.

In addition, for example, when a cluster associated with a 3D object is constructed based on density of a point using a 3D density-based spatial clustering of applications with noise (DBSCAN) clustering algorithm, a data structure about a point and grid tree can be generated. In some implementations, a knowledge distillation (KD) tree structure can be included therein. When DBSCAN is applied, a 3D classification tool, such as POINTNET^{TM} (source: https://github.com/charlesq34/pointnet), can be used.

Furthermore, when S200 is performed in the graph node-based region growing technique, a data structure (e.g., MeshGraph or the like) can be generated about a graph node.

As described above, in S200, the process of constructing a data structure can be performed in consideration of the application of various clustering techniques. In some implementations, a data structure can be generated in such a manner as to overlay desired attribute information in a pixel of image data input from the LiDAR 120.

In S300 of FIG. 2, the clustering technique selected in S200 can be applied on a class-by-class basis according to a priority of the seed class.

Implementations of the present disclosure can differentially set a threshold range of a prediction score for determining a priority for each seed class. For example, a minimum of prediction score applied to all classes can be set and reference points of another prediction score can be set for each class to be used to determine a priority of a class.

In some cases, there can be a predetermined seed class priority. The predetermined priority can vary depending on the specific clustering technique selected in S200 for each class.

For example, the pole category may be prioritized in the BEV-based 2D region growing technique, the vehicle technique or the others may be prioritized in the RV-based region growing technique or the BEV-based 2.5D region growing technique, and the sign or fence category may be prioritized in the graph node-based region growing technique. In the 3D DBSCAN technique, for example, the pedestrian category may be prioritized.

In S300 of FIG. 2, when applying a different clustering technique depending on a priority for each seed class, it should be noted that a “search” related root point or grid uses only a seed list, but a target point targets all point lists to which an ID is not assigned. For example, when feature points included in each clustering technique are analyzed and when the feature points are analyzed as being similar to each other, the class may change to a class different from before to be clustered. As such, according to implementations of the present disclosure, some misclassified points can be corrected to a class label.

For reference, in S310 in FIG. 2, an average of AI prediction scores can be obtained on a seed class-by-seed class basis to determine a priority to be applied in S300. In this case, two different thresholds can be used, such as a total average threshold of an AI prediction score and an AI prediction score threshold to be applied to an individual class, are defined in S320.

In S330, it may be determined whether the two thresholds are met for each seed class. If at least one threshold is not met, then a determination of NO is performed in S330 to proceed to S360. In S360, a clustering technique can be applied using predetermined seed class priority information, rather than calculating the priority.

If it is determined in S330 that the threshold condition is met, then in S340, respective seed classes can be sorted in an order of AI prediction score average values to determine a priority. In S350, the clustering technique can be applied on a seed class-by-seed class basis depending on the priority.

In S400, noise processing can be performed on a cluster-by-cluster basis. In S500, information can be generated on a cluster-by-cluster basis.

A representative feature point of the cluster can be generated based on the points included in the cluster, and a threshold of the representative feature point can be adjusted to perform noise processing. Thereafter, information for shape analysis can be generated and updated for clusters discriminated as being normal.

For example, the number of points, a cluster size, density of a cluster group, eigen-values, a minimum or maximum Z value, means intensity, or the like can be included as the representative feature point of the cluster.

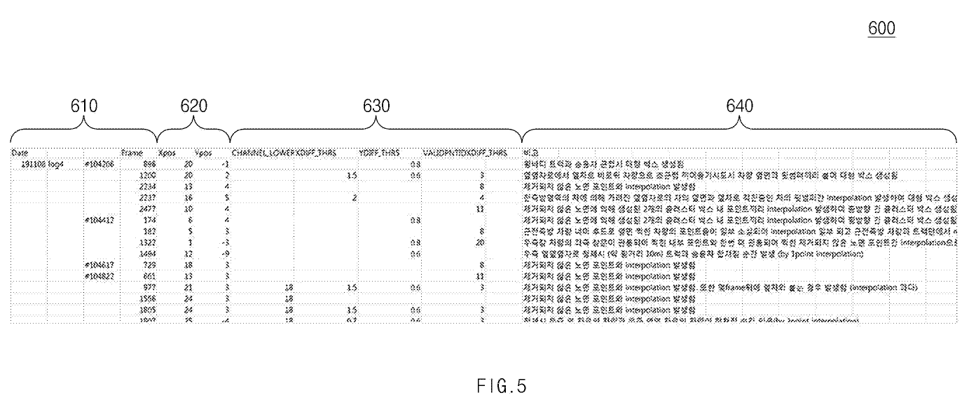

FIG. 5 is a drawing for describing an example of a process of performing noise processing on a cluster-by-cluster basis, e.g., as described in S400 of FIG. 2, to generate cluster unit information according to an implementation of the present disclosure.

The example of FIG. 5 illustrates an accumulation table 600 of malfunction occurrence data for 2D LUT tuning based on an ROI. Reference numeral 610 indicates malfunction occurrence data information and reference numeral 620 indicates coordinates. Reference numeral 630 indicates a minimum or maximum threshold capable of being illustratively set to prevent malfunction and reference numeral 640 is a portion illustrating a malfunction situation.

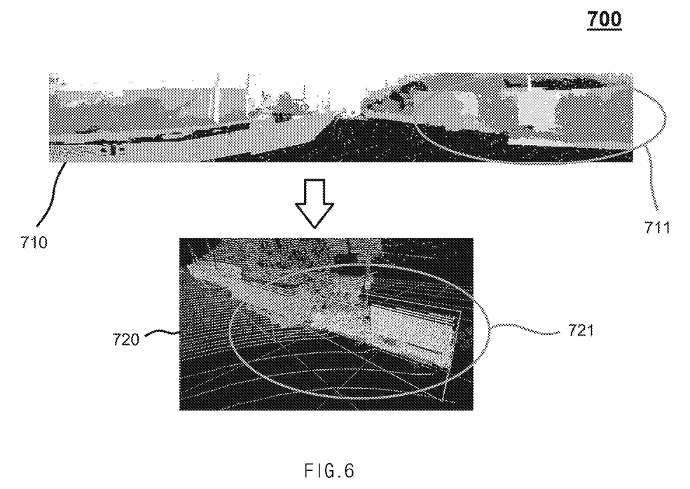

FIG. 6 is a drawing illustrating an example of an experimental result 700 of applying an AI clustering algorithm for a LiDAR point cloud to correct misrecognition for an object according to an implementation of the present disclosure.

In some scenarios, before applying implementations of the present disclosure, it may be checked that objects which belong to several classes, such as a special vehicle, a fence, and the other structures, are output in a mixed state, as shown in reference numeral 711 in an AI recognition result 710, when applying a segmentation and clustering process to a point cloud recognized by a LiDAR sensor 120.

However, when applying an algorithm 200 according to implementations of the present disclosure, it may be checked that the existing misrecognition region 711 is accurately recognized as a new class, such as a car in the comprehensive concept or a comprehensive structure, as shown in reference numeral 721 in a new AI recognition result 720. It is noted that object classes included in the new AI recognition result 720 of FIG. 7 are not a seed class. The seed class will be understood as the concept of an intermediate class passed to improve misrecognition of an object in a process before S100.

FIG. 7 is a block diagram illustrating an example of a computing system 1000 for autonomous vehicle control and object recognition calculation according to an implementation of the present disclosure.

Referring to FIG. 7, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the implementations disclosed in the specification may be directly implemented with a hardware module, a software module, or a combination of the hardware module and the software module, which is executed by the processor 1100. The software module may reside on a storage medium (i.e., the memory 1300 and/or the storage module 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to exemplary implementations and the accompanying drawings, the present disclosure is not limited thereto, but may be variously modified and altered by those skilled in the art to which the present disclosure pertains without departing from the spirit and scope of the present disclosure claimed in the following claims.

Therefore, implementations of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An artificial intelligence (AI)-based system configured to perform clustering of light detection and ranging (LiDAR) point cloud data, the system comprising:
at least one processor; and
at least one memory storing computer program instructions that, based on being executed by the at least one processor, perform operations of object recognition for recognizing an object in a surrounding environment based on point cloud data obtained from at least one LiDAR sensor, the operations comprising:
obtaining point cloud data from at least one LiDAR sensor;
determining a plurality of classes respectively corresponding to a plurality of objects detected in the point cloud data;
executing class merging for the plurality of classes to obtain a plurality of seed classes, wherein a number of the plurality of seed classes is smaller than a number of the plurality of classes;
generating a seed point list composed of a plurality of seed points respectively corresponding to the plurality of seed classes;
selecting a clustering scheme for the point cloud data and generating a data structure for the selected clustering scheme;
determining a clustering priority for the plurality of seed classes; and
segmenting the point cloud data to which the data structure is applied, depending on the clustering priority, and applying the selected clustering scheme to the segmented point cloud data to generate a plurality of clusters.

2. The system of claim 1, wherein the operations further comprise:
calculating a representative feature point corresponding to each of the plurality of clusters generated according to the selected clustering scheme, from among points included in each cluster; and
adjusting a threshold for each of the representative feature points in units of each cluster to generate feature point information in units of a cluster in which noise is removed.

3. The system of claim 1, wherein the executing of the class merging comprises:
performing dimension reduction of the point cloud data and aggregating two or more classes from among the plurality of classes into one seed class, based on a feature distance.

4. The system of claim 1, wherein the data structure includes one of a data structure for a range view (RV) pixel map, a data structure for a bird’s eye view (BEV) pixel map, a data structure for a BEV voxel map, or a density-based spatial clustering of applications with noise (DBSCAN)-based tree data structure.

5. The system of claim 1, wherein the clustering priority is determined based on an average value of prediction scores for the plurality of seed points.

6. The system of claim 5, wherein based on the average value of the prediction scores does not satisfying a threshold range, a predetermined seed class order is determined as the clustering priority.

7. The system of claim 6, wherein the threshold range is differently set for different seed classes among the plurality of seed classes.

8. The system of claim 1, wherein an object recognition result for the point cloud data is corrected by a seed class, based on applying the selected clustering scheme.

9. The system of claim 2, wherein the representative feature point corresponding to each cluster includes one of a number of the points in the cluster, a size of the cluster, a density of the cluster, an eigen-value, a Z minimum value or a Z maximum value, or a means intensity.

10. The system of claim 2, wherein the operations further comprise:
redefining, as a final class for the point cloud data, a class assigned for each object that is recognized after the noise is removed in the result to which the selected clustering scheme is applied.

11. An artificial intelligence (AI)-based method for performing clustering of light detection and ranging (LiDAR) point cloud data, the method comprising:
obtaining point cloud data from at least one LiDAR sensor;
determining a plurality of classes respectively corresponding to a plurality of objects detected in the point cloud data;
executing class merging for the plurality of classes to obtain a plurality of seed classes, wherein a number of the plurality of seed classes is smaller than a number of the plurality of classes;
generating a seed point list composed of a plurality of seed points respectively corresponding to the plurality of seed classes;
selecting a clustering scheme for the point cloud data and generating a data structure for the selected clustering scheme;
determining a clustering priority for the plurality of seed classes; and
segmenting the point cloud data to which the data structure is applied, depending on the clustering priority, and applying the selected clustering scheme to the segmented point cloud data to generate a plurality of clusters.

12. The method of claim 11, further comprising:
calculating a representative feature point corresponding to each of the plurality of clusters generated according to the selected clustering scheme, from among points included in each cluster; and
adjusting a threshold for each of the representative feature points in units of each cluster to generate feature point information in units of a cluster in which noise is removed.

13. The method of claim 11, wherein the executing of the class merging comprises:
performing dimension reduction of the point cloud data and aggregating two or more classes from among the plurality of classes into one seed class, based on a feature distance.

14. The method of claim 11, wherein the data structure includes one of a data structure for a range view (RV) pixel map, a data structure for a bird’s eye view (BEV) pixel map, a data structure for a BEV voxel map, or a density-based spatial clustering of applications with noise (DBSCAN)-based tree data structure.

15. The method of claim 11, wherein the clustering priority is determined based on an average value of prediction scores for the plurality of seed points.

16. The method of claim 15, wherein based on the average value of the prediction scores does not satisfying a threshold range, a predetermined seed class order is determined as the clustering priority.

17. The method of claim 16, wherein the threshold range is differently set for different seed classes among the plurality of seed classes.

18. The method of claim 11, wherein an object recognition result for the point cloud data is corrected by a seed class, based on applying the selected clustering scheme.

19. The method of claim 12, wherein the representative feature point corresponding to each cluster includes one of a number of the points in the cluster, a size of the cluster, a density of the cluster, an eigen-value, a Z minimum value or a Z maximum value, or a means intensity.

20. The method of claim 12, further comprising:
redefining, as a final class for the point cloud data, a class assigned for each object that is recognized after the noise is removed in the result to which the selected clustering scheme is applied.
